(19) United States
(12) Patent Application Publication
(10) Pub. No.: US 2025/0060950 A1
(43) Pub. Date: Feb. 20, 2025

(54) GRAPHICAL TOOL FOR CREATING CUSTOM MULTIMEDIA TASK GUIDANCE PROCEDURES

(71) Applicant: CareAR Inc., Norwalk, CT (US)

(72) Inventors: Ben PINKERTON, Powell, OH (US); Fritz EBNER, Pittsford, NY (US); Chetan GANDHI, New York, NY (US); Kevin SUMMERS, Richardson, TX (US); Vimal NAIK, Parsippany, NJ (US)

(21) Appl. No.: 18/451,331

(22) Filed: Aug. 17, 2023

(51) Int. Cl. G06F 8/38; G06F 3/04842; G06F 3/04845; G06F 8/34; G06T 13/20; G06V 10/764

(52) U.S. Cl. CPC G06F 8/38; G06F 3/04842; G06F 3/04845; G06F 8/34; G06T 13/20; G06V 10/764

(57) ABSTRACT

The present invention provides a graphical tool to create custom multimedia workflows. The graphics tool is marketed as Experience Builder (EB). One implementation of EB is implemented as software as a service (SAAS) services featuring software for real-time collaboration on shared documents, data capturing, live video communications to support remote equipment and product repair, replacement, and maintenance services, and IT support services for products, services, and operations. Using EB enables authors to create their own visual instructions for customers and technicians. EB is a no-code workflow creation tool to develop process flows, such as, self-service guides, training guides, service bulletins, warranty process steps, and checklists. Optional generative AI is also available.

### BACKGROUND OF THE INVENTION

The present application generally relates to a graphical tool for designing workflows, more specifically, a graphical tool to create custom multimedia workflows.

Workflow generation software allows an author to use visual tools to help automate human and system-based processes. Many workflow management tools enable the implementation of complex business processes involving multiple integration points with existing systems, such as, single sign-on (SSO) authentication, enterprise resource planning (ERP), and human resource (HR) applications, delivered through web portals.

Workflow generation software are also used to create guidance procedures to help users navigate service management tasks, customer service procedures, and more. Examples of guidance procedures include inspection checklists/procedures, troubleshooting guides, unboxing/setup of consumer electronics, maintenance procedures, product orientation, and training.

Although workflow creation tools exist across many domains, today's workflow creation tools don't integrate all the components needed to create a compelling multimedia guidance procedure.

Further, today's workflow creation tools experience is not simple enough that authors can quickly create experiences in a “what you see is what you get” (WYSIWYG) manner.

### SUMMARY OF THE INVENTION

Disclosed is a novel system and computer-implemented graphics tool for creating a structured series of graphical widgets on a graphical user interface (GUI) of a computer system. The graphical widgets form part of a multimedia guidance procedure.

The software graphics tool enables authors to create their own visual instructions for customers and technicians. The tool is a no-code workflow creation tool to develop multimedia-rich process flows, such as, self-service guides, training guides, service bulletins, warranty process steps, checklists, and more. Optional generative AI is also available.

Broadly, the software graphics tool begins with receiving, via a GUI, an author's input for populating multimedia content into a UI card design pattern for a multimedia guidance procedure. The UI card design pattern is a flexible-size container visually resembling a playing card that groups related information. The author's input may include text, audio, images and 3-D objects, and video. The 3-D objects may include an orientation to present to the user. A user can further manipulate the 3-D objects through panning, rotating, and zooming.

Further, the UI card design pattern includes buttons. The author uses this button to enable an action to be performed when selected by the user. The action to be performed may be navigation to another UI card design pattern, image recognition, state recognition, audio recognition, or a combination.

Further, the input may include a position of a search field to insert into the flexible-size container. The author's input may include a relationship between two or more UI design patterns on the GUI as one of a hierarchical relationship or another relationship therebetween.

Next, a portion of the author's input is converted into one or more search parameters for a search query. This search query is compatible with a search engine, a public database query, a private database query, or a combination of these.

The search parameters are associated with a search field inserted into the flexible-size container.

The author may overlay a guidance icon on a portion of the 3-D object to indicate that further information related to that portion is available. Animations using images applied to the 3-D object may also be added by the author. Object and state detection machine learning models can be incorporated into the multimedia guidance procedure. The author may select, via the GUI, an object and state detection machine learning model from a plurality of object and state detection machine learning models. Next, the author may select a label in a machine learning model corresponding to a portion of the object. The object and state detection machine learning model using the selected object and state detection machine learning model starts once the user captures an image using a camera. Typically, the author will provide further input via the GUI to designate a first action in response to detecting the portion of the object being successful. Also, the author will provide further input via the GUI to designate a first action in response to detecting the portion of the object being unsuccessful.

In another example using optional generative AI, the software graphics tool enables authors to create their own visual instructions for customers and technicians using generative AI. Broadly, the software graphics tool begins with receiving, via a GUI, an author's input for populating multimedia content into a multimedia guidance procedure as part of a workflow creation tool.

Optionally, the author's input may include a location of a video and a corresponding timestamped transcript of the video (optionally generated speech recognition). In another example, the author's input may include a location of a document or manual.

Next, the author enters an input or prompt that specifies their goal, e.g., ‘create instructions to replace the oil filter’. The author's entry is converted into a query that is compatible with a deep learning system. The query includes a format of the response from the generative deep learning system. The format of the response can be specified. For example, the response may be formatted as a structured query in data exchange format, such as JSON. Optionally, in the case of a video, the input may be converted into a corresponding timestamped transcript into the query.

Next, the query is sent to the generative deep learning system. Optionally for video, if a number of inputs exceed the acceptable number, sending the corresponding timestamped transcript to the generative deep learning system to create a summary and using in place of the corresponding timestamped transcript the summary which has been created to form the structured query.

Next, a response from the generative deep learning system is received. And a portion of the response is automatically inserted into the workflow of the creation tool to populate graphical widgets on the GUI. Optionally, if a manual is included as part of the author's input, one or more of the graphical widgets may be populated with images that have been automatically extracted from the document.

Next, optionally, an author may evaluate the response from the generative deep learning system to determine whether to update the author's input, e.g., content, format, or a combination. The evaluation may include an evaluation of images extracted from the video in temporal proximity to each timestep associated with a step in the generated response.

Next, optionally, based on the evaluation being unacceptable, the author may provide further input to create the porting of the multimedia guidance procedure. Otherwise, if the evaluation is acceptable, the response for the generative deep learning system is automatically inserted into the workflow of the creation tool.

### BRIEF DESCRIPTION OF DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example screenshot of a graphical author interface (GUI) illustrating three UI card design patterns that group related information in a flexible-size container visually resembling playing cards to allow an author to create a portion of a multimedia guidance procedure, in accordance with one embodiment of the present invention;

FIG. 2 is another example screenshot of a GUI, illustrating ten UI card design patterns with various options and various inputs for the author to select, in accordance with one embodiment of the present invention;

FIG. 3 is another example screenshot of a GUI illustrating various options that the author may manage a library of multimedia guidance procedures or experiences, in accordance with one embodiment of the present invention;

FIG. 4 is another example screenshot of a GUI illustrating four populated UI card design patterns with various information provided by the author, including text, images, and video for four UI card design patterns, in accordance with one embodiment of the present invention;

FIG. 5 is another example of a GUI illustrating types of information that can be used to populate the UI card design patterns with various information provided by the author, in accordance with one embodiment of the present invention;

FIG. 6 is another example screenshot of a GUI illustrating receiving to designate a relationship between the three UI card design patterns on the GUI as a decision tree relationship in accordance with one embodiment of the present invention;

FIG. 7 is an example screenshot of a GUI that a portion of the multimedia guidance would experience that was previously prepared by an author that a technician or user would see, in accordance with one embodiment of the present invention;

FIG. 8 is an example screenshot of a GUI illustrating some of the analytics collected by the multimedia guidance procedure when used by an author, in accordance with one embodiment of the present invention;

FIG. 9 is an example screenshot of a GUI illustrating receiving author input to designate an orientation of a 3D image in the multimedia guidance procedure, in accordance with one embodiment of the present invention;

FIG. 10 is an example screenshot of a GUI from FIG. 9 illustrating receiving author input to orient a 3-D object with a hot spot to render in the multimedia guidance procedure, in accordance with one embodiment of the present invention;

FIG. 11 is an example screenshot of a GUI illustrating a user's experience in response to the author animating a portion of a 3-D object to render with a hot spot in accordance with one embodiment of the present invention;

FIG. 12 is an example screenshot of a GUI illustrating a user's experience in response to the author invoking the use of object and state detection machine learning model-powered computer vision to validate at least a portion of an image in an image database for a step in the multimedia guidance procedure, in accordance with one embodiment of the present invention;

FIG. 13 is an example screenshot of a GUI from FIG. 12 illustrating receiving author input based on the object and state detection machine learning model being successful and a response based on the object and state detection machine learning model being unsuccessful, in accordance with one embodiment of the present invention;

FIG. 14 is an example screenshot of a GUI illustrating seven populated UI card design patterns with various information provided by the author, including text, images, and video, and a hierarchical relationship between the four UI card design patterns, in accordance with one embodiment of the present invention;

FIG. 15A through 15C is a high-level flow for automatically associating search parameters with a search field to populate a UI card design pattern that groups related information in a flexible-size container visually resembling playing cards on a GUI to allow an author to create a portion of a multimedia guidance procedure, in accordance with one embodiment of the present invention;

FIG. 16 is a high-level flow for automatically inserting at least a portion of the generated response from the generative deep learning system into the workflow creation tool to populate one or more graphical widgets on a GUI, in accordance with one embodiment of the present invention;

FIG. 17 is a high-level flow for automatically inserting at least a portion of the generated response from the generative deep learning system using video into the workflow creation tool to populate one or more graphical widgets on a GUI, in accordance with one embodiment of the present invention;

FIG. 18 is a high-level flow for automatically inserting at least a portion of the generated response from the generative deep learning system using a service manual into the workflow creation tool to populate one or more graphical widgets on a GUI, in accordance with one embodiment of the present invention;

FIG. 19A through 19C is an additional high-level flow combining aspects of FIG. 16 through FIG. 18 for automatically inserting at least a portion of the generated response from the generative deep learning system into the workflow creation tool to populate one or more graphical widgets on a GUI, in accordance with one embodiment of the present invention; and

FIG. 20 is an example of computer architecture that can implement methods of FIGS. 1-19 described herein, in accordance with one embodiment.

### DETAILED DESCRIPTION OF THE INVENTION

As required, detailed embodiments are disclosed herein; however, it is to be understood that the disclosed embodiments are merely examples and that the systems and methods described below are embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather to provide an understandable description.

One aspect of the present invention provides a graphical tool to create custom multimedia workflows. The graphics tool is marketed as CareAR® Experience Builder (EB), available from CareAR Inc. One implementation of EB is implemented as software as a service (SAAS) services featuring software for real-time collaboration on shared documents, data capturing, live video communications to support remote equipment and product repair, replacement, and maintenance services, and IT support services for products, services, and operations.

EB is a software tool that enables authors to create their own visual instructions for customers and technicians. EB is a no-code workflow creation tool to develop process flows such as: self-service guides, training guides, service bulletins, warranty process steps, checklists, and other documents.

Authors using EB create easy-to-follow step-by-step instructions for customers and workers. Self-solve guidance document built with EB solution increases customer satisfaction, reduces downtime, increases first-time fix rate, reduces product returns, and more. EB eliminates the need for a designer or training pro. EB solution provides a simple drag-and-drop, step-by-step web-based graphical authoring as the foundation for no-code content creation.

It's easy to use nodes and wires to connect pages in the canvas to create simple author guidance or complex branching flows.

EB allows novice authors as well as expert authors to create complex task guidance procedures easily and quickly. Features of EB include the ability to see what you are building with zero wait time and giving immediate feedback to understand what the end author will see. Another feature is EB integrates AI functionality directly into the experience to create vibrant experiences without having to understand the underlying technology. EB integrates with a service provider such as ServiceNow® from ServiceNow Inc. to update and create service tickets.

EB is a drag-and-drop with a WYSIWYG interface. Authors are given the ability to create workflows that include steps that can incorporate 2D content, 3D content, AI services, integrations with 3rd parties, and call escalations. EB includes:
2D: create a new page that looks like it will on the user's device
2D: build complex navigation through drag and drop interface
2D: incorporate images, text, and videos
3D: add and view 3D models
3D: annotate 3D objects with custom information

### Non-Limiting Definitions

The terms “a”, “an” and “the” are intended to include the plural forms as well unless the context clearly indicates otherwise.

As used herein, the term “about” or “approximately” applies to all numeric values, whether or not explicitly indicated. These terms generally refer to a range of numbers that one of skill in the art would consider equivalent to the recited values (i.e., having the same function or result). In many instances, these terms may include numbers that are rounded to the nearest significant figure. As used herein, the terms “substantial” and “substantially” means, when comparing various parts to one another, that the parts being compared are equal to or are so close enough in a dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

The phrases “at least one of <A>, <B>, . . . and <N>” or “at least one of <A>, <B>, . . . <N>, or combinations thereof” or “<A>, <B>, . . . and or <N>” are defined by the Applicant in the broadest sense, superseding any other implied definitions hereinbefore or hereinafter unless expressly asserted by the Applicant to the contrary, to mean one or more elements selected from the group comprising A, B . . . and N, that is to say, any combination of one or more of the elements A, B . . . or N including any one element alone or in combination with one or more of the other elements which may also include, in combination, additional elements not listed.

The term “computer” or “computing means” is used to describe any computer processor executing computing instructions, including a mobile phone, tablet, laptop, desktop computer, a server, a web service, to carry out the method of the present invention.

The term “connected” or “coupled” means an element is connected to another element, it can be directly connected or coupled to the other element or intervening elements may be present. In contrast, when an element is referred to as being “directly connected” or “directly coupled” to another element, there are no intervening elements present.

The term “hierarchical relationship” is the broader and narrower (parent/child) relationships between logical records (where each record represents a concept).

The term “graphical widget” is an element of a graphical author interface that displays information or provides a specific way for an author to interact with the operating system (OS) or an application. Widgets include the following: icons, pull-down menus, buttons, selection boxes, progress indicators, on-off checkmarks, scroll bars, windows, window edges that let you resize the window; toggle buttons; and devices for displaying information and inviting, accepting, and responding to author actions.

The term “multimedia” is any combination of one or more of text, pictures, images, symbols, drawings, videos, audio, or a combination.

The term “search-box” or “search field” is a graphical control element with the dedicated function of accepting author input to be searched for in a database.

The term “token” is analogous to pieces of words. Before the API processes the input, the input is broken down into tokens. These tokens are not cut up exactly where the words start or end-tokens can include trailing spaces and even sub-words. Here are some helpful rules of thumb for understanding tokens in terms of lengths: 1 token ˜=4 chars in English, 1 token ˜=¾ words, 100 tokens ˜=75 words.

The term “UI card design pattern” is a UI card design pattern that groups related information in a flexible-size container visually resembling a playing card.

### Graphical Tool Overview

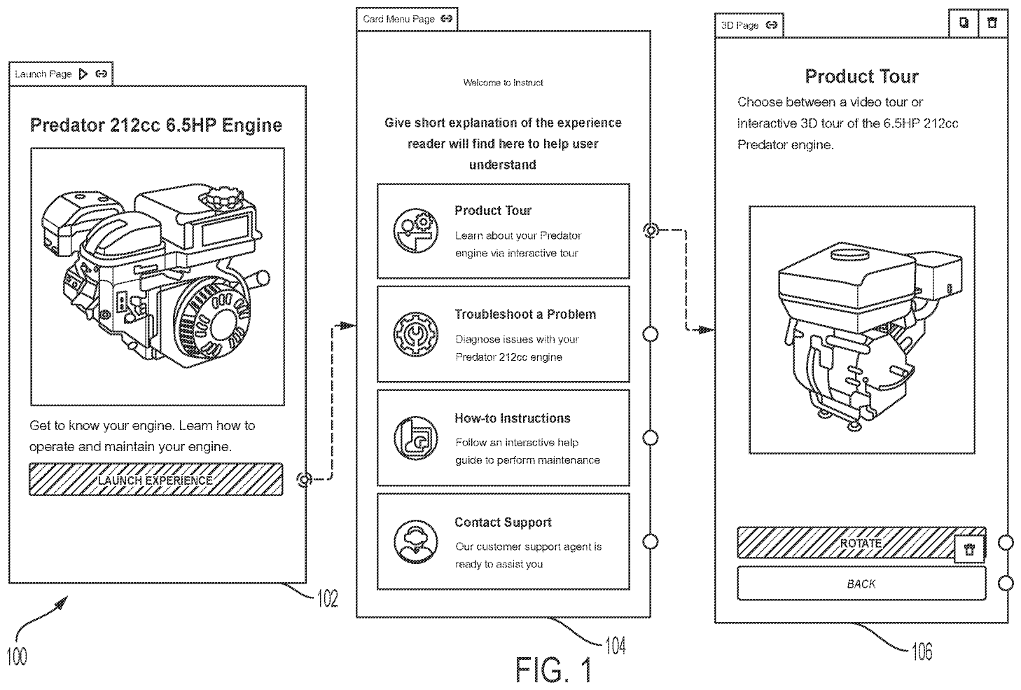

FIG. 1 through FIG. 14 are example screenshots of the graphical tool 100. Turning to FIG. 1, shown is EB with customizable templates with hotspot focus, as further explained below, to make it easy to craft engaging step guidance with unique speed and efficiency. Utilize a selection of page templates to quickly get started creating an experience and customize each page to an author's specific needs. Authors can create customized multimedia guidance procedures without software coding.

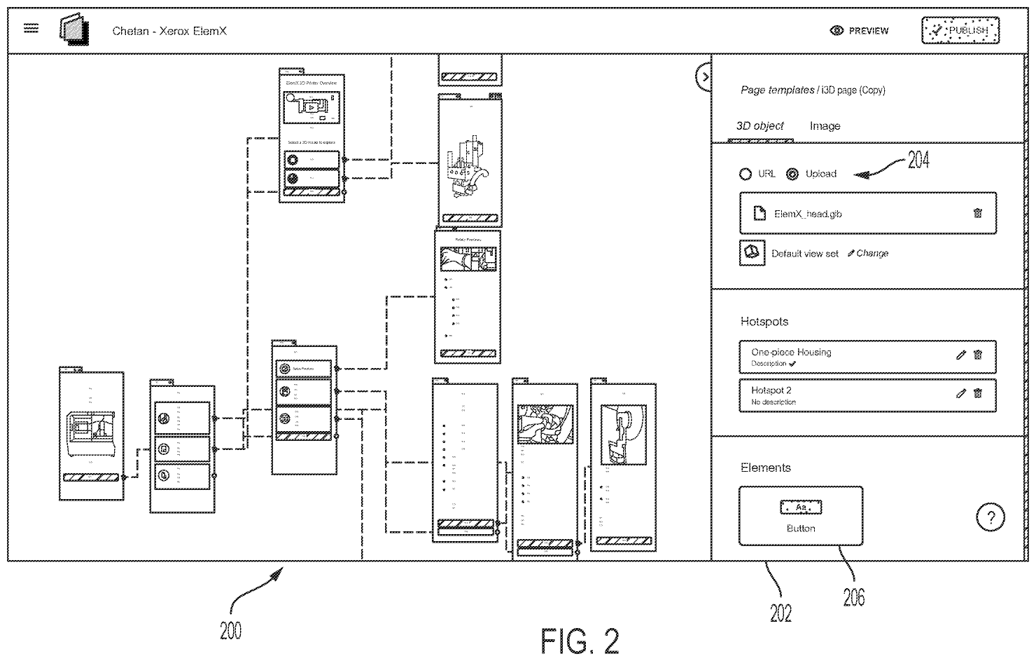

The customizable templates in EB make it welcoming to greet technicians, customers, and others with customized graphics and QR codes. Drag-and-drop direction includes hot spot placement with rich card detail for each step 102, 104, 106. EB allows authors to preview and test author workflows in a simulator or on an author's device, such as a smartphone, tablet computer, or laptop. See FIG. 2 illustrating another example of a GUI 200, illustrating ten UI card design patterns with various options 202 and various inputs 204, including buttons 206 for the author to select. As is discussed further below, buttons may be placed by the author for a user to take various actions. These actions may include navigation to another UI card design pattern, image recognition, state recognition, audio recognition, or a combination thereof.

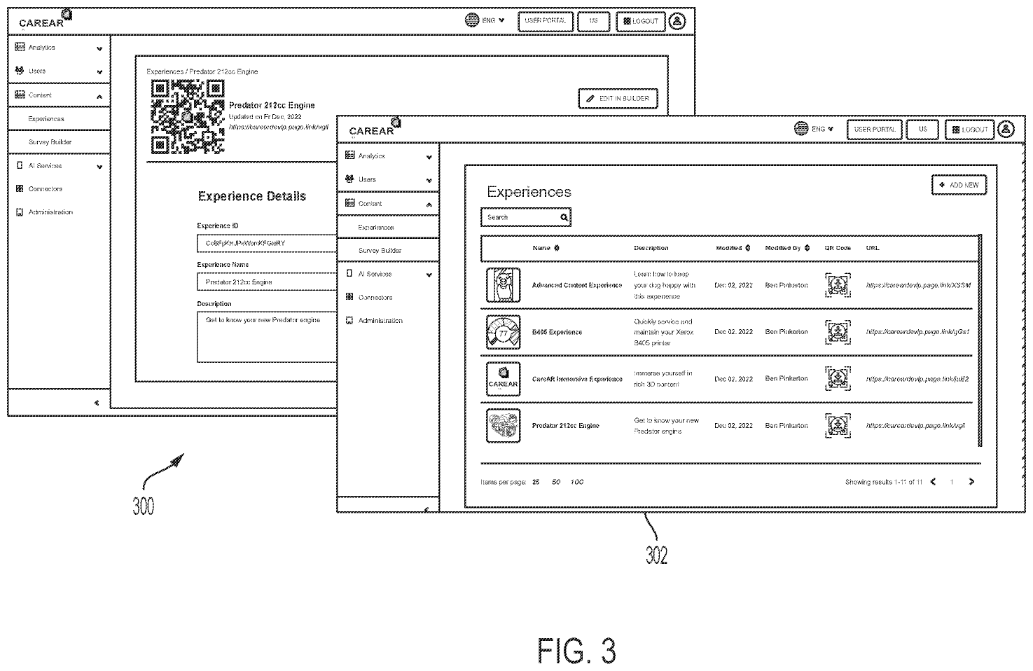

Authors can publish with one click to push content to browser or app authors with the most recent updates. Technicians and authors can invoke the content with a QR code or a link. These links and QR codes are managed by the authors as part of the content creation. The author manages a library 302 with details for each customizable multimedia workflow. This is shown in FIG. 3 in GUI 300.

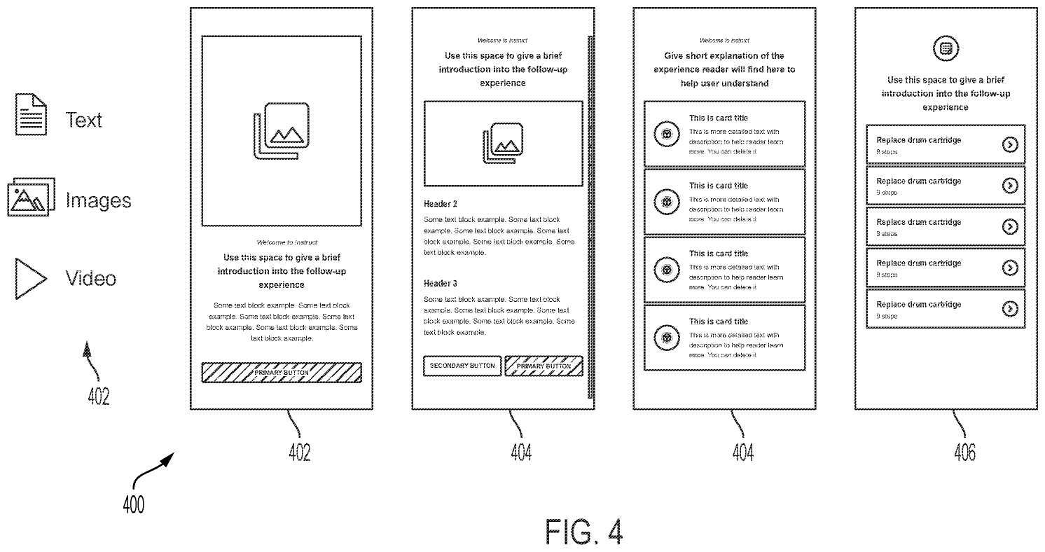

See FIG. 4 is another example of a GUI 400 illustrating four populated UI card design patterns 402, 404, 404, 406 with various information provided by the author, including text, images, and video 402, and a hierarchical relationship between the four UI card design patterns.

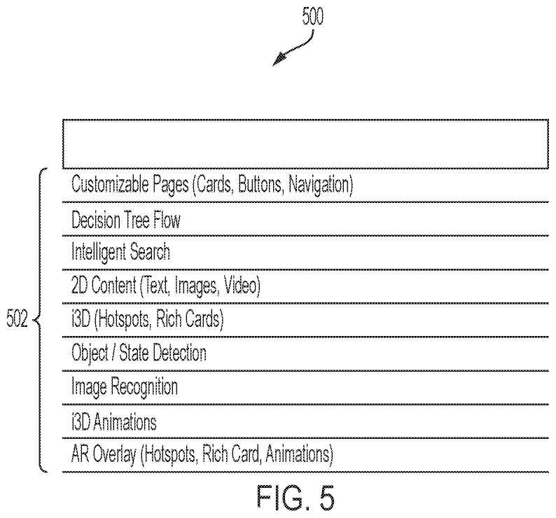

It's easy to use nodes and wires to connect pages in the canvas to create simple author guidance or complex branching flows. FIG. 5 is another example 500 of a GUI illustrating types of information (Customizable Pages (Cards, Buttons, Navigation), Decision Tree Flow, Intelligent Search, 2D Content (Text, Images, Video), i33 (Hotspots, Rich Cards), Object and State Detection, Image Recognition, i3D Animations, AR Overlay (Hotspots, Rich Cards Animations) 502 that can be used to populate the UI card design patterns with various information provided by the author.

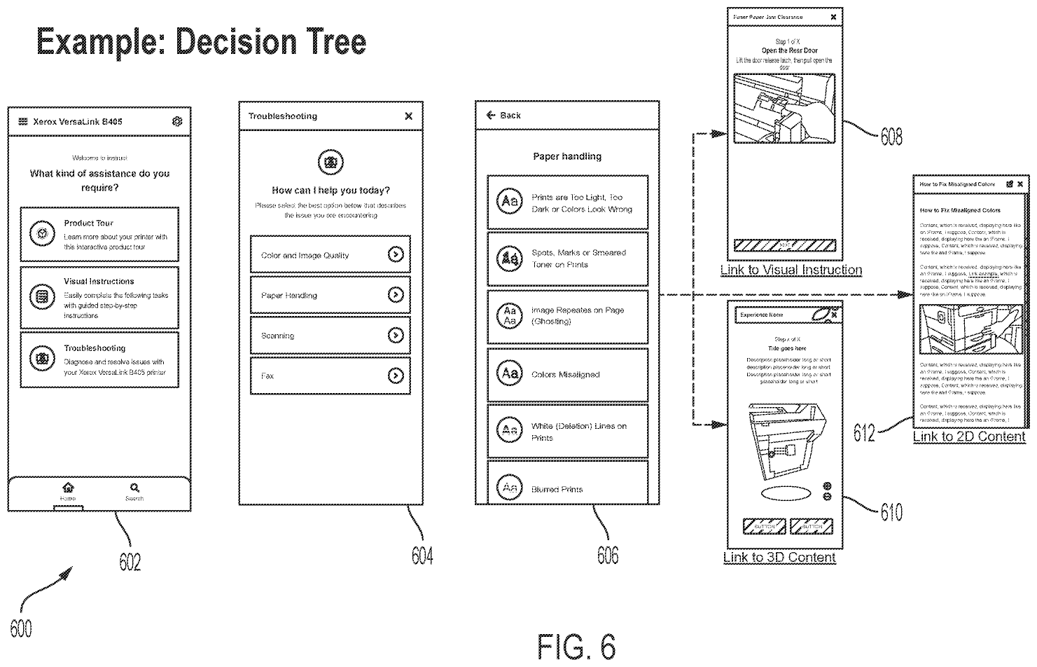

EB provides authors with a self-guided tool with drag-and-drop visuals to create customized workflows using a web-based palette with drag-and-drop page templates and connectors between UI card design patterns. The use of hot spots enables authors to define interaction points with supplemental content for users to view. The UI card design patterns are assembled into simple or complex visual workflows. See FIG. 6 is another example of a GUI 600 illustrating receiving author input to designate a relationship between the three UI card design patterns 602, 604, 606, 608, 610, and 612 on a GUI as a decision tree relationship 606 to 612 with nodes and connector. Authors can integrate existing or new 2D images, 3D content, and video. Updates to workflows are instantly available to authors. The self-guided tool enables building navigation through drag and drop interface with the incorporation of images, text, videos, 3D images, and orientations of the 3D image shown.

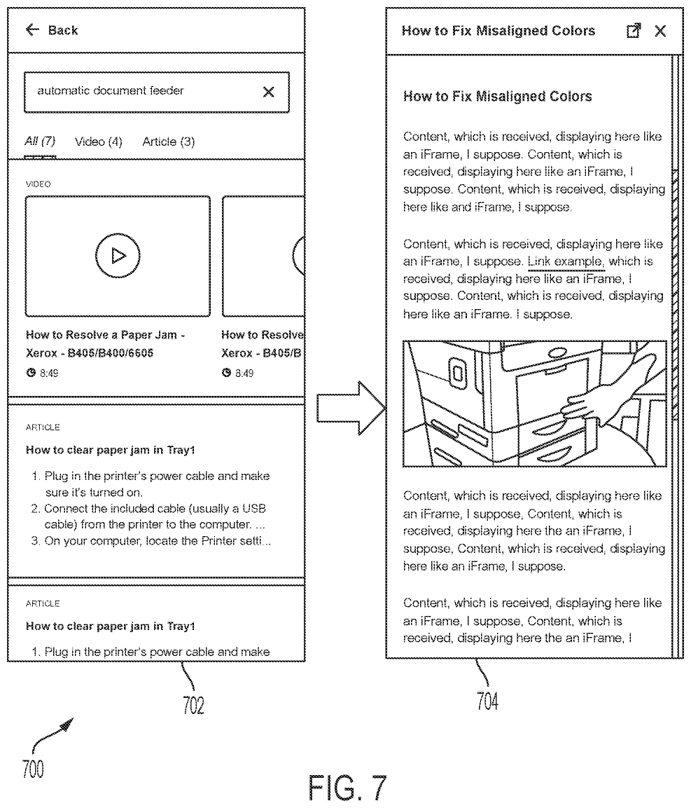

FIG. 7 shows an example of a GUI 700 of a portion of the multimedia guidance procedure 700 prepared by an author that a technician or user would see 702, 704 on the user's device.

Technicians and other authors are greeted and are immediately engaged with customized multimedia workflows that may include a launch page with graphics, instructions, and QR codes. The technician's attention is focused on graphical hot spots in the 3D device image with rich card information for each step in the workflow.

In another example, the author includes prepopulated search fields using CSV/JSON to help the author and technician with relevant queries to databases and the Internet.

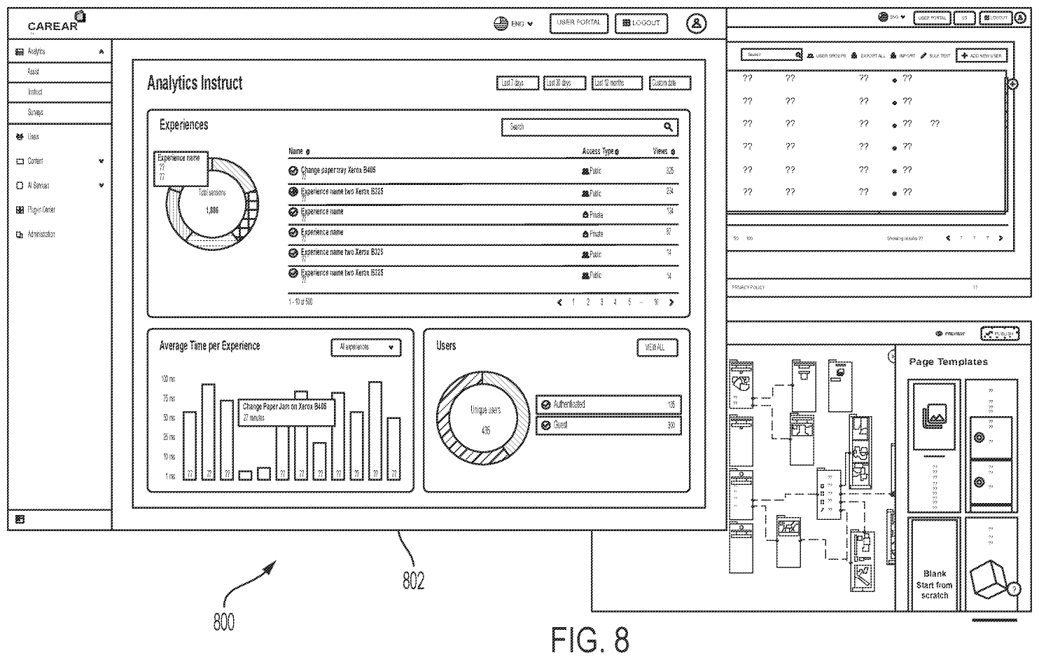

FIG. 8 is an example of a GUI 800 illustrating some of the analytics 802 collected by the multimedia guidance procedure when used by an author.

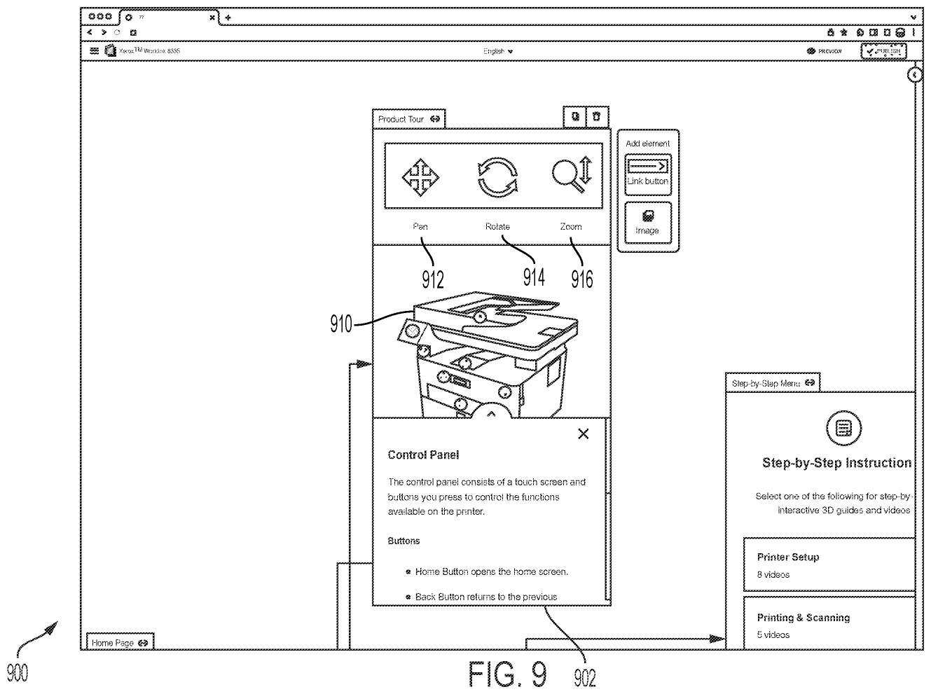

FIG. 9 is an example of a GUI 900 illustrating receiving author input via buttons to pan 912, rotate 914, and zoom 916, for designating an orientation of a 3-D object 910 in a multimedia guidance procedure.

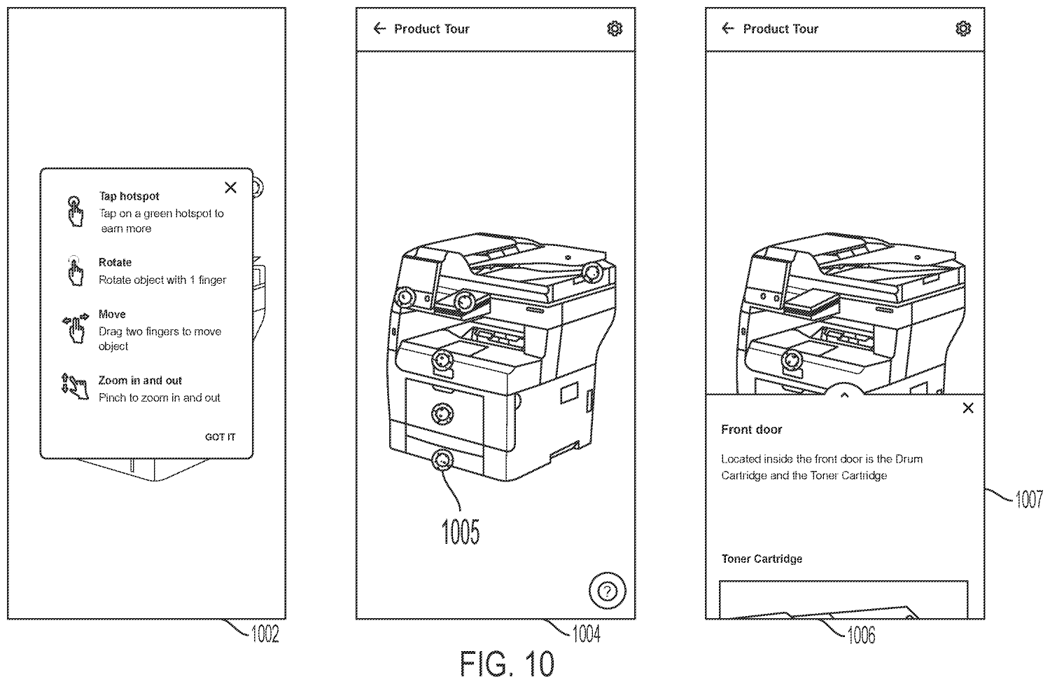

FIG. 10 is an example of a GUI from FIG. 9 illustrating receiving author input to orient a 3-D object 902 with a hot spot 1002, 1004, 1006 to render in the multimedia guidance procedure. The hot spot designates additional information 1007.

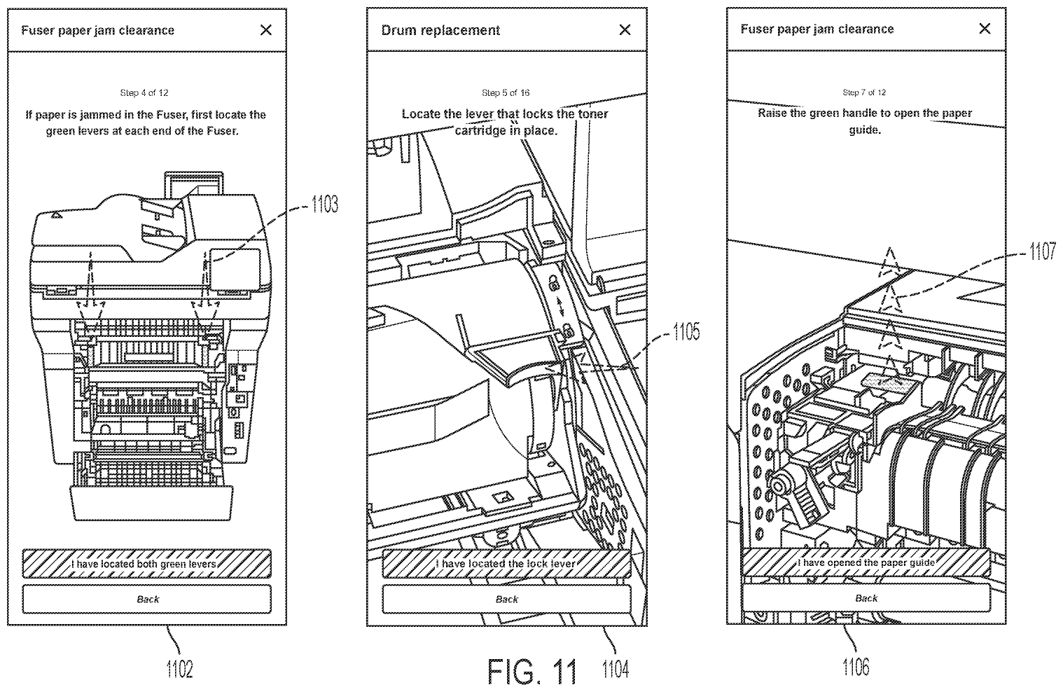

FIG. 11 is an example of a GUI illustrating a user's experience in response to the author animating a portion of a 3-D object to render with a hot spot 1102, 1104, 1106. As shown, 3D annotations 1103, 1105, 1107 are added to denote further information.

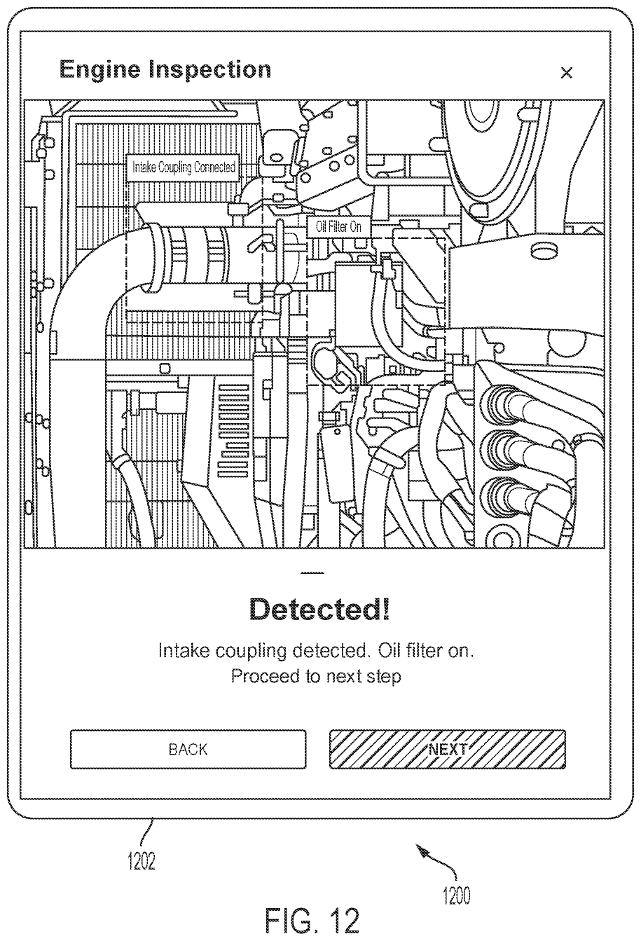

FIG. 12 is an example of a GUI 1200 illustrating a user's experience in response to the author invoking the use of object and state detection machine learning model 1202 using machine learning-powered computer vision to validate at least a portion of an image in an image database for a step in the multimedia guidance procedure. This object and state detection machine learning model is described in the incorporated references at the end of this section.

AI real-time visual verification as described in the incorporated references at the end of this section:
AI: real-time visual verification that a task step has been successfully completed
AI: visually determine guidance steps based on Machine Learning detection results

AI Perception Tasks as described in the incorporated references at the end of this section:
computer vision detection of an object or an object's state
audio verification of a task step completion
action verification of a task step
any combination of verification modalities

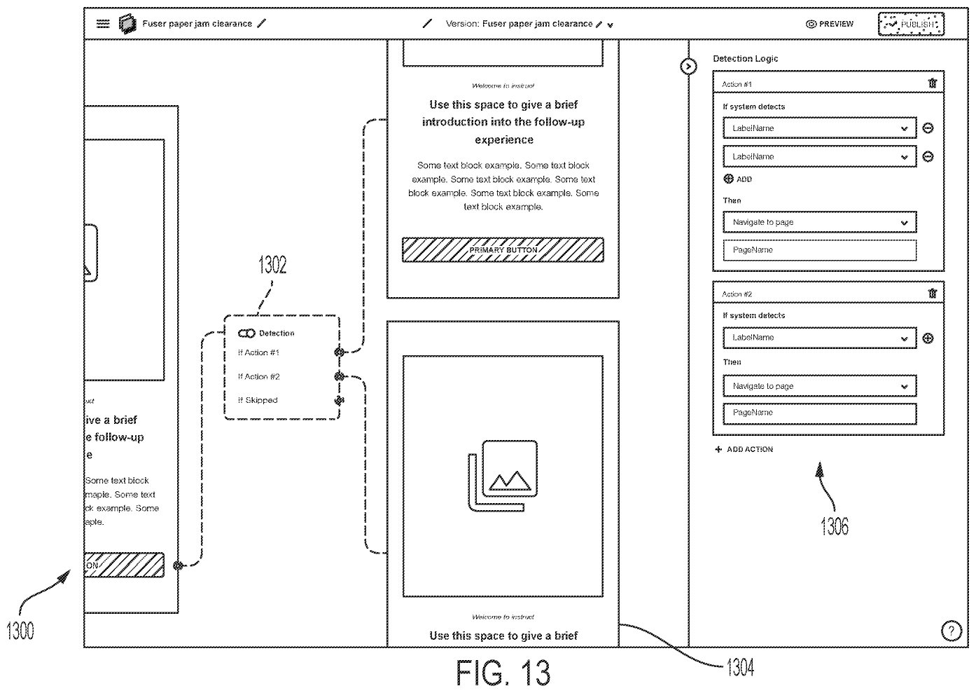

FIG. 13 is an example of a GUI 1300 from FIG. 12 illustrating receiving author input 1302, 1304, 1306 based on the object and state detection machine learning model being successful and a response based on the object and state detection machine learning model being unsuccessful.

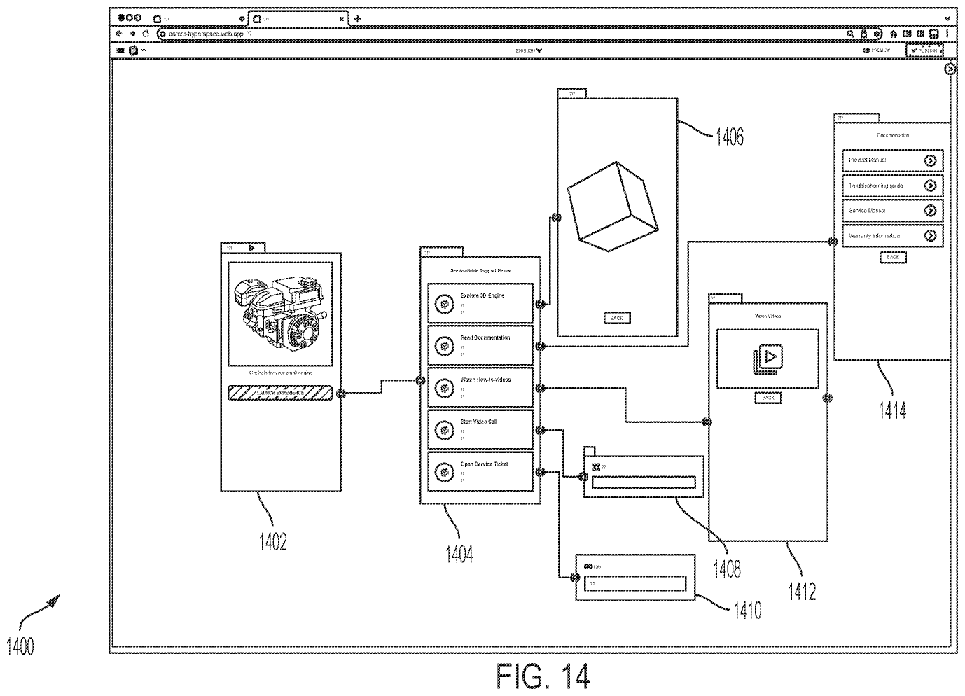

FIG. 14 is an example of a GUI 1400 illustrating seven populated UI card design patterns 1402, 1404, 1406, 1408, 1410, 1412, 1414 with various information provided by the author, including text, images and video, and a hierarchical relationship between the four UI card design patterns.

Flow Diagram for Creating Multimedia Task Guidance Procedures with Prepopulated Search Field and Cards as UI Card Design Pattern

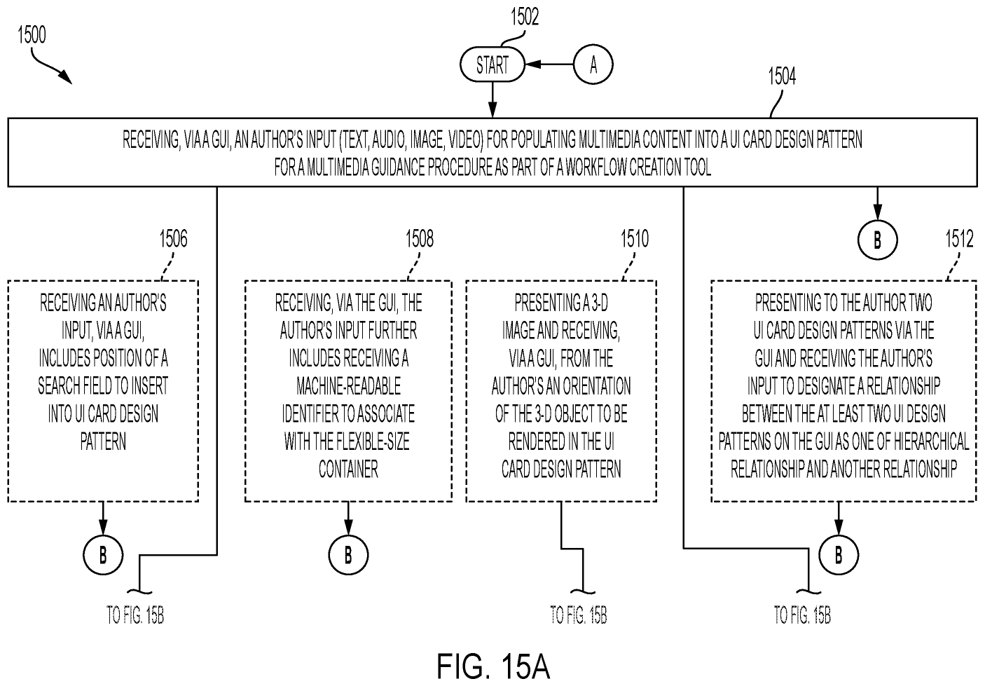

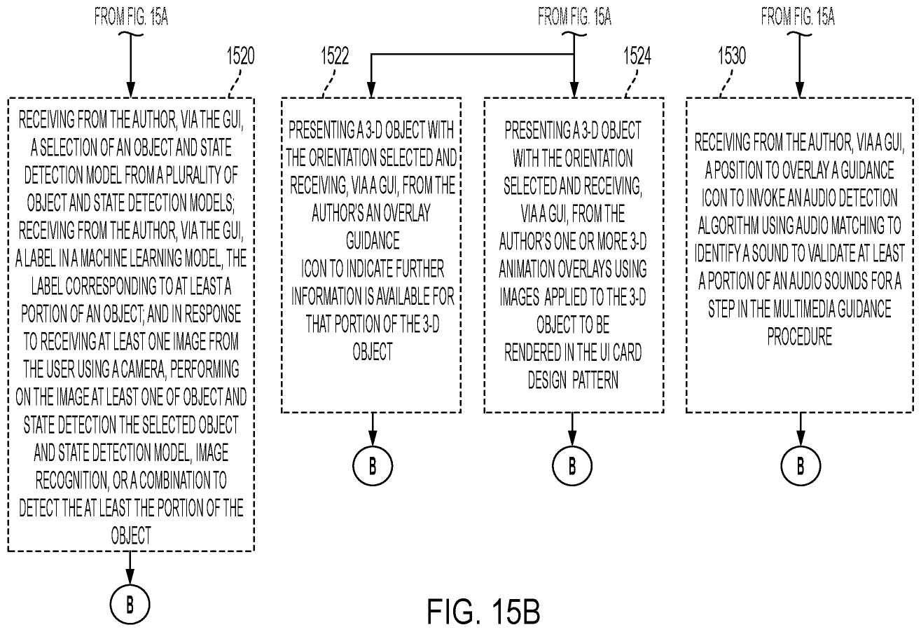

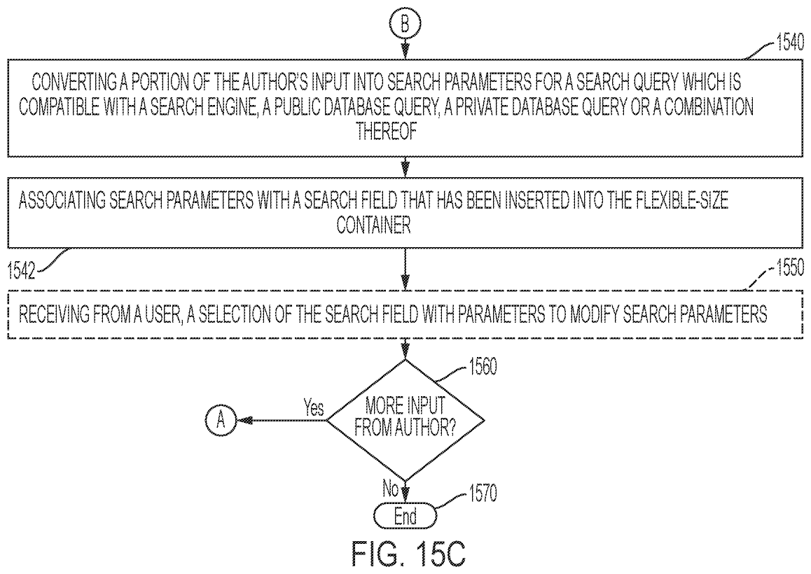

FIG. 15A through FIG. 15C is a high-level flow 1500 for automatically associating search parameters with a search field to populate a UI card design pattern that groups related information in a flexible-size container visually resembling playing cards on a GUI to allow an author to create a portion of a multimedia guidance procedure, in accordance with one embodiment of the present invention. The process begins in step 1502 and immediately proceeds to step 1504.

In step 1504, an author's input is received via a GUI. The input is for populating multimedia content into a UI card design pattern that groups related information in a flexible-size container visually resembling a playing card for at least a portion of a multimedia guidance procedure as part of a workflow creation tool. The tool provides an interactive design environment with a collection of features for editing and placement of text, audio, pictures, and video. The interactive GUI with flexible-size containers is shown in FIGS. 1, 2, 4, 6, and 9-14 as described above. The process continues to step B or various optional inputs as illustrated using boxes with the broken line style 1506, 1508, 1510, 1512, 1520, 1522, 1524, 1530, 1532, and 1550 as shown.

An interactive search may include
AI: search a knowledge base for relevant information and create context-sensitive searches based on visual or other contexts (e.g., hotspots on 3D models, buttons, etc.)
AI: search an image database for similar images and perform actions based on different matches
AI: Generative Deep Learning System-based enablement to create experiences from various media (simple input, videos, or author/service manuals)
Integration: Post and Get information, including images captured by a camera (on a mobile device) to a 3rd party, e.g., ServiceNow, and associate the information with a work order ID defined by the 3rd party
Escalation: Start a session with tools that enable human-to-human assistance (Assist session call escalation)

As shown, optional input 1506 from the author via a GUI, may include a position of a search field to insert into UI card design pattern. The process continues to step B.

Optional input 1508 from the author via the GUI, may include receiving a machine-readable identifier, such as a bar code or QR code, to associate with the flexible-size container. The process continues to step B.

Optional input 1510 from the author via the GUI may include an orientation of the 3-D object to be rendered in the UI card design pattern. This is shown in FIG. 10, described above. The process continues to one more of the optional steps 1522, 1524, and 1526.

Optional input 1512 from the author via the GUI may include designating a relationship between at least two UI design patterns on the GUI as hierarchical relationship or another relationships. This is shown in FIGS. 1, 2, 4, 6, and 9-14, as described above. The process continues to step B.

Referring to FIG. 15B, optional input 1520 from the author via the GUI may include receiving from the author, via the GUI, an object and state detection machine learning model from a plurality of object and state detection machine learning models. The optional input may further include a label in a machine learning model, the label corresponding to at least a portion of an object. This is shown in FIG. 12 and FIG. 13. Other optional steps, not shown, such as receiving further author's input, via the GUI, to designate a first action in the multimedia guidance procedure to take in response to detecting the portion of the object being successful. Likewise, optionally the author may designate a second action in the multimedia guidance procedure to take in response to detecting the portion of the object being unsuccessful. The process continues to step B.

Optional steps 1530 and 1532 flow from step 1504. In step 1530 object and state machine learning model detection analysis is performed using audio matching. The process continues to step B.

Eventually, after one or more optional steps described above, the process continues to connector B in FIG. 15C. In step B the process continues to step 1540.

In step 1540, at least a portion of the author's input is converted into search parameters for a search query that is compatible with a search engine, a public database query, a private database query, or a combination thereof. The process continued to step 1542.

In step 1542, search parameters are associated with a search field that has been inserted into the flexible-size container. The process continued to step 1572.

Optional input 1550, receiving from a user as opposed to the author, a selection of the search field with parameters to modify search parameters. The process continued to step 1560.

In step 1560, a test is made whether more input from the author is requested. In the event that no more input is provided by the author via the GUI, the process ends in step 1570. Otherwise, if more input is received from the author via the GUI, the process continues to connector A in FIG. 15, as shown.

In addition to the above, other optional features include allowing the author to manually convert or use machine translation to offer text and audio to be presented to the user in more than one national language, such as English, Spanish, Arabic, French, Russian, Portuguese, German, Hindi, Japanese, Cantonese Chinese, Bengali, Mandarin Chinese, and others. Examples of machine translation software include Xerox Easy Translator Service, Google Translate, Bing Microsoft Translate, and others.

Further optional features include importing and exporting the multimedia task guidance procedure. The multimedia task guidance procedure may be imported and exported in the same workstation or across workstations by different authors or different tenants. As an example, the tenant may include a group of users who share a common access with specific privileges to the software instance. Or in another example, multi-tenancy is where a single occurrence of a software application serves numerous clients. Every client is known as a tenant.

In one example, the multimedia task guidance is serialized to a JSON format. The serialized JSON format can be deserialized to the GUI on the same machine from which is saved or shared and imported into another workstation or different tenants. Further, in addition to importing and exporting, the multimedia task guidance procedure may be stored in versions automatically or manually. Each version represents a backup of the multimedia guidance procedure at an earlier point in time.

### Flow Diagram for Creating Multimedia Task Guidance Procedures Using Generative Deep Learning Models

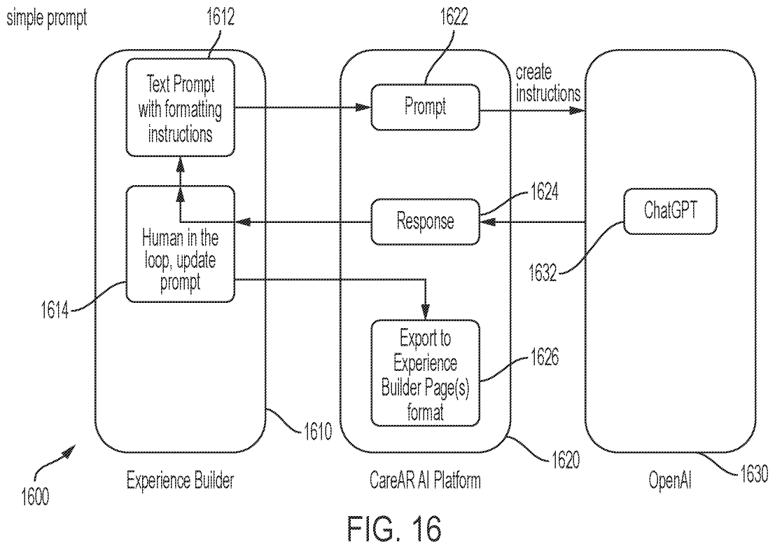

FIG. 16 is a high-level flow 1600 for automatically inserting at least a portion of the generated response from the generative deep learning system into the workflow creation tool to populate one or more graphical widgets on the GUI as part of a multimedia guidance procedure. There are three major aspects to this process. An authoring tool 1610, commercially available as Experience Builder by CareAR, an Artificial Intelligence (AI) Interface Module 1620, and Generative AI Platform 1630, such as, ChatGPT from OpenAI. The high-level flow begins with the authoring tool 1610. The authoring tool 1610 receives the author's input 1612 for populating multimedia content into at least a portion of a multimedia guidance procedure as part of a workflow creation tool. The author's input includes a prompt and formatting instructions 1612 of the response. There may be default information and default formatting instructions. The process flows into step 1622 as part of the AI Interface Module 1620.

Next, in step 1622, the author enters an input or prompt that specifies their goal, e.g. ‘create instructions to replace the oil filter’. The author's entry is combined with system-generated text that specifies the format of the response. The combined input the AI Interface Module 1620 converts the text prompt from step 1612 into a query which is compatible with a generative deep learning system, the query with formatting instructions of a response from the generative deep learning system. The formatting instructions may include the number of steps, specific units of measure, or the task for which the multimedia guidance procedure is being created. The process continues to step 1632 as part of the Generative AI Platform 1630.

In step 1632, the query, including formatting instructions, is sent from the AI Interface Module 1620 to the Generative AI Platform 1630, and a response 1624 is received by the AI Interface Module 1624. The response is sent to the Authoring Tool 1610 for the author's review in step 1614.

In step 1614, the author reviews the response. The review may include validating that the return format is correct or may include further editing of the response itself or editing the format of the response. After review, the author may either i) further work on the text prompt and formatting in step 1612 or export the response automatically in step 1626 to be inserted into the workflow creation tool to populate graphical widgets on the GUI as part of a multimedia guidance procedure.

### Generative Deep Learning System-Enabled Experience Creation: Simple Prompt

the author enters a prompt
experience builder directs Generative Deep Learning System to complete the prompt with a specific simple return structure, e.g., JSON step/description pairs
experience builder converts simple prompt completion JSON to an experience shows author for validation/editing.
   Use GPT-4 or similar Large Language Models
Summary
   a. Derive a summary of the discussed content
Text
   a. Create step-by-step instructions
   b. Suggest a relevant checklist
   c. Question: How do we determine the steps to be split within & across pages
Image & Video
   a. Display a set of relevant images/video frames for each step
   b. Provide option to add image/video, edit or enhance images via DALL-E (text to image)
Include additional content into the instructional content
   a. Identify and highlight potential safety hazards for this procedure
   b. Add compliance issues by incorporating industry-specific guidelines and best practices
      Flow Diagram for Creating Multimedia Task Guidance Procedures Using Generative Deep Learning Models with Video Input

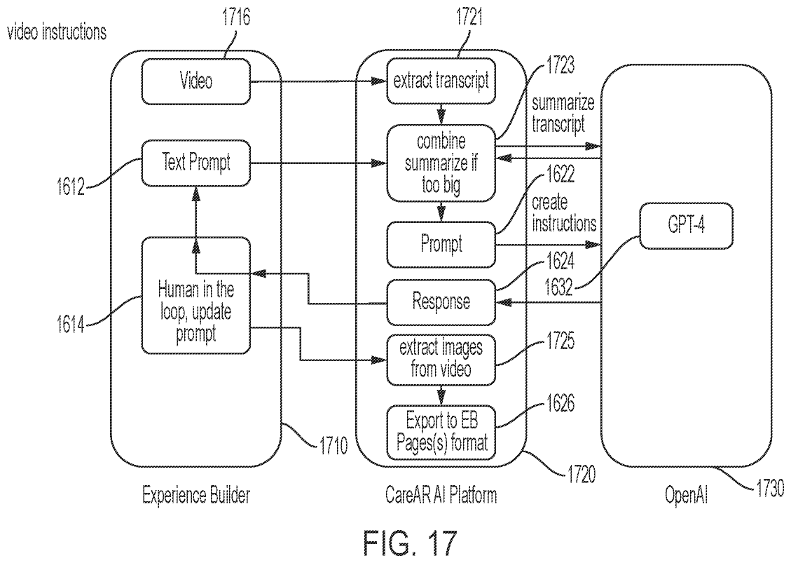

FIG. 17 is a high-level flow 1700 for automatically inserting at least a portion of the generated response from the generative deep learning system using video into the workflow creation tool to populate one or more graphical widgets on the GUI as part of a multimedia guidance procedure. Unlike the more general case described above for FIG. 17, in this example, the author's input includes a video. The reference numerals from FIG. 17 refer to identical or functionally similar elements.

As described above, the process begins with the authoring tool 1710. The authoring tool 1610 receives the author's input for populating multimedia content into at least a portion of a multimedia guidance procedure as part of a workflow creation tool. The author's input includes a prompt and formatting instructions 1612 of the response. The author's input also includes a video 1716. The video may optionally include a timestamped script. In the case that a transcript is available as part of the video, the transcript is extracted in step 1721 as part of the AI Interface Module 1720.

In the case that a timestamped script is not available for the video, a timestamp may be created from the audio using speech recognition by the authoring tool 1710. The timestamp may be sentence-level timestamps or some other frequency of timestamps. The system may also minimize the timestamped script may be further reduced by discarding any unnecessary text. In one example, the timestamped script may be sent to the Generative AI system 1730 to receive a summary. In step 1723, as part of the AI Interface Module 1720, the combination of the transcript and prompt may be checked to make sure the number of tokens is less than the maximum number of tokens permitted by the Generative AI system 1730. There may be default information and default formatting instructions. The process flows into step 1622 as part of the AI Interface Module 1720. The process flows into step 1622.

In step 1622, the AI Interface Module 1720 converts the text prompt from step 1612 into a query which is compatible with a generative deep learning system, the query with formatting instructions of a response from the generative deep learning system. The formatting instructions may include the number of steps, specific units of measure, or the task for which the multimedia guidance is procedure is being created. The process continues to step 1632 as part of the Generative AI Platform 1730.

In step 1632, the query, including formatting instructions, is sent from the AI Interface Module 1620 to the Generative AI Platform 1730, and a response 1624 is received by the AI Interface Module 1622. The response is sent to the Authoring Tool 1710 for the author's review in step 1714.

In step 1714, the author reviews the response. The review may include validating that the return format is correct, or the author may continue editing the response itself or editing the format of the response. After review, the author may either i) further work on the text prompt and formatting in step 1612 or in step 1725, images from the video are extracted to include in the multimedia guidance procedure. The images may be extracted from the video around the timestamp for each step. Or optionally gives the user a method to extract their own sample images for each step. The author may then review these images. The process continues to step 1626.

In step 1626, the response is automatically exported to be inserted into the workflow creation tool to populate graphical widgets on the GUI as part of a multimedia guidance procedure.

### Generative Deep Learning System-Enabled Experience Creation: From Video Prompt

the author enters a video reference

Experience Builder takes the following steps:
retrieve the video and audio and, optionally, a timestamp-annotated transcript
create a timestamped transcript from audio if the annotated transcript is not available
direct Generative Deep Learning System to create a set of task steps from the timestamped transcript with a specific simple return structure
e.g., JSON step/description pairs
extract sample images from the video around the timestamp for each step (optionally give the author a method to extract their own sample images for each step)
Convert to experience and show to the author for validation/editing
   Flow Diagram for Creating Multimedia Task Guidance Procedures Using Generative Deep Learning Models with a User Manual

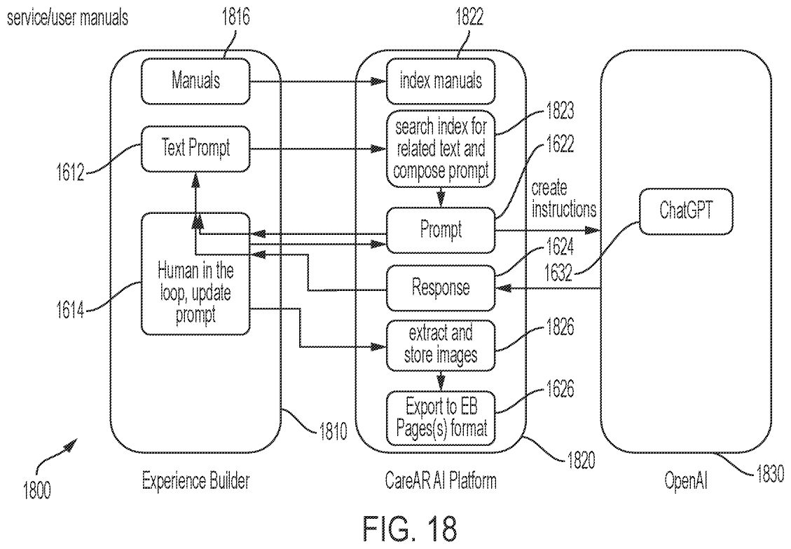

FIG. 18 is a high-level flow 1800 for automatically inserting at least a portion of the generated response from the generative deep learning system using a service manual into the workflow creation tool to populate one or more graphical widgets on the GUI as part of a multimedia guidance procedure. Unlike the more general case described above for FIG. 16, in this example, the author's input includes a video. The reference numerals from FIG. 16 refer to identical or functionally similar elements.

As described above, the process begins with the authoring tool 1610. The authoring tool 1610 receives the author's input for populating multimedia content into at least a portion of a multimedia guidance procedure as part of a workflow creation tool. The author's input includes a prompt and formatting instructions 1612 of the response. The author's input also includes a manual 1816, such as a user manual or product manual, or some other documentation. The manual may include an index. In the case that the manual includes, a semantic search of the index 1822 is performed, and the result is combined in step 1823 with the author's input 1612.

In the case that an index is not available. It can be created using automatic indexing tools, including PDF Index Generator. The index which was generated is combined in step 1822 with the author's input 1612. The process flows into step 1622 as part of the AI Interface Module 1620. The process flows into step 1622.

In step 1622, the AI Interface Module 1620 converts the text prompt from step 1612 into a query which is compatible with a generative deep learning system, the query with formatting instructions of a response from the generative deep learning system. The formatting instructions may include the number of steps, specific units of measure, or the task for which the multimedia guidance procedure is being created. The process continues to step 1632 as part of the Generative AI Platform 1630.

In step 1632, the query, including formatting instructions, is sent from the AI Interface Module 1620 to the Generative AI Platform 1630, and a response 1624 is received by the AI Interface Module 1622. The response is sent to the Authoring Tool 1610 for the author's review in step 1614.

In step 1614, the author reviews the response. The review may include validating the return format is correct or to continue editing the response itself or editing the format of the response. After review, the author may either i) further work on the text prompt and formatting in step 1612 or in step 1826, images from the manual are extracted to include in the multimedia guidance procedure. The images may be extracted from the manual from the pages in which the prompt was created. The author may then review these images. The process continues to step 1626.

In step 1626, the response is automatically exported to be inserted into the workflow creation tool to populate graphical widgets on the GUI as part of a multimedia guidance procedure.

### Generative Deep Learning System-Enabled Experience Creation: From Author/Service Manuals

author uploads manuals to experience builder
the author enters a prompt for the specific task they want to have an experience created for
experience builder takes the following steps:
ingest manuals, convert manuals to semantic indexes for searching
search semantic indexes for information about the author's prompt for task guidance, and return token-limited context to provide to Generative Deep Learning System
direct Generative Deep Learning System to create a set of task steps from the queried indexes and prompt and return in a simple format
e.g., JSON step/description pairs
Extract sample images from manuals and provide to the author for selection for each task step. Optionally rank images based on relevancy to simplify author selection.
Convert to experience and show to the author for validation/editing author validates or updates experience

### Source Data Options

scour the Internet (public data)—Text, Images, Video & 3D Models
import Author Manuals OR Knowledge Articles—Text & Images
import Video—Text (from Audio Transcription), Audio & Video
import Service Management Ticket details

### Flow Diagram for Creating Multimedia Task Guidance Procedures Using Generative Deep Learning Models for Multiple Types of Input Sources

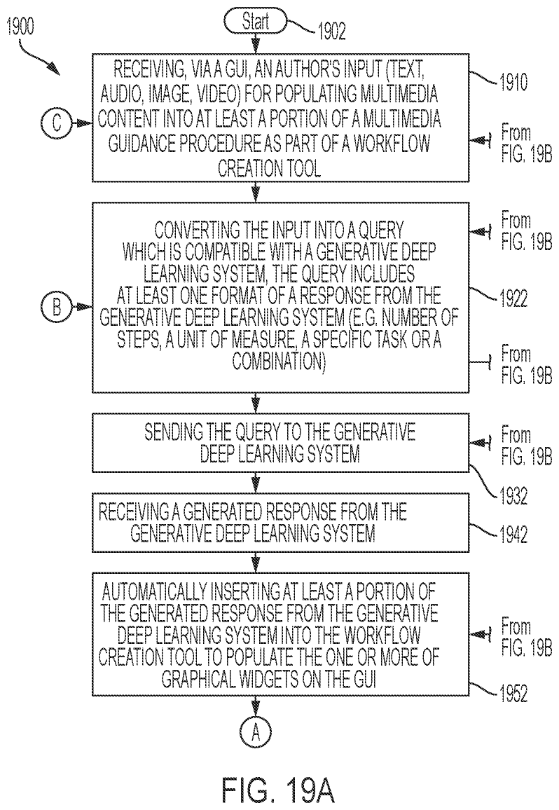

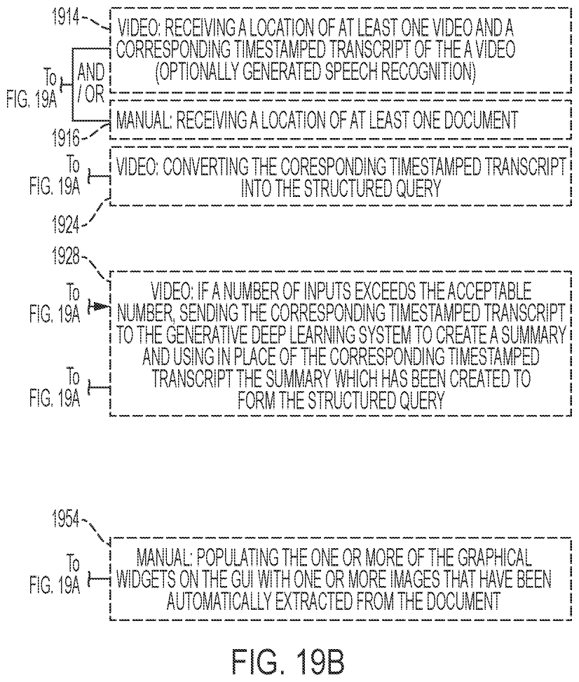

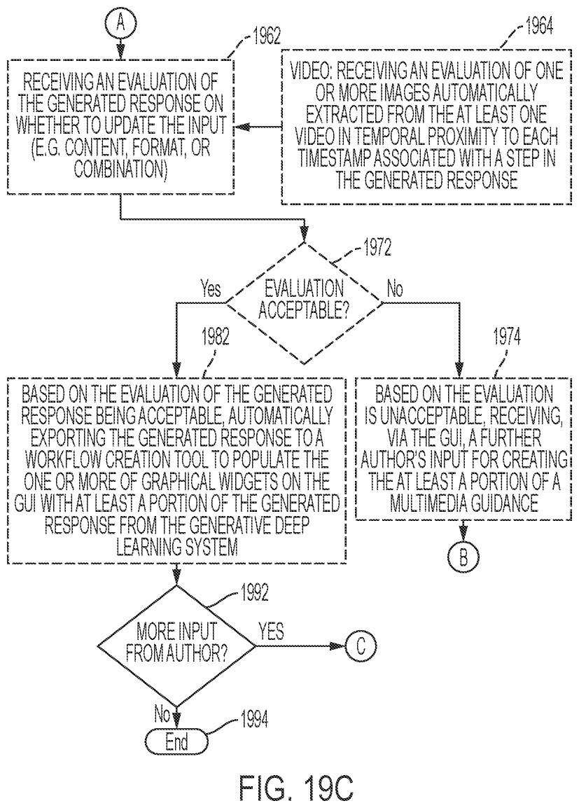

FIG. 19 is an additional high-level flow combining aspects of FIG. 17 through FIG. 19 for automatically inserting at least a portion of the generated response from the generative deep learning system into the workflow creation tool to populate one or more graphical widgets on the GUI.

The process begins with step 1902 and immediately proceeds to step 1912. In step 1912, an author's input (text, audio, image, video) is received via an interactive GUI for populating multimedia content into at least a portion of a multimedia guidance procedure as part of a workflow creation tool. The interactive GUI with flexible-size containers is shown in FIGS. 1, 2, 4, 6, and 9-14 as described above. Two other optional inputs i) video 1914 and ii) user manual 1916 are shown. None, one or both of these optional inputs are possible. Optional video input 1914 includes receiving a location of a video and a corresponding timestamped transcript of the video. If a transcript is unavailable, it may be created using speech recognition. Optional user manual input includes receiving a location of a document. The process continues to step 1922.

In step 1922, the input from step 1912, is converted into a query (e.g., human-readable data interchange format) which is compatible with a generative deep learning system. The query includes at least one format of a response from the generative deep learning system, e.g., a number of steps, a unit of measure, a specific task, or a combination. Similar to step 1912 above, there are two optional steps for just video. Two other optional video steps 1924, 1926 are shown. None, one, or both of these optional inputs are possible. Optional video input 1924 includes converting the corresponding timestamped transcript into the query. Optional video input 1926 determines if the number of inputs exceeds an acceptable number, sending the corresponding timestamped transcript to the generative deep learning system to create a summary and using in place of the corresponding timestamped transcript the summary which has been created to form the structured query. The process continues to step 1932.

In step 1932, the query is sent to the generative deep learning system. The process continues to step 1942.

In step 1942, a generated response is received from the generative deep learning system. The process continues to step 1952.

In step 1952, a portion of the generated response is automatically inserted from the generative deep learning system into the workflow creation tool to populate the one or more of the graphical widgets on the GUI. An optional step 1952, if manual input was used in step 1916, one or more of the graphical widgets is populated on the GUI with images that have been automatically extracted from the document. The process continues to connector A for FIG. 21.

FIG. 19C is a continuation of the high-level flow of FIGS. 19A and 19B, the connector A into step 1962. In step 1962, an evaluation of the generated response is received from the author on whether to update the input, e.g., content, format, or combination. The process continues to decision block 1972.

In step 1972, a decision block on whether the evaluation is acceptable. If the evaluation is not acceptable, the process continues to step 1974.

Step 1974, is an optional step, based on the evaluation that is unacceptable, receiving, via the GUI, a further author's input for creating the portion of the multimedia guidance procedure. The process continues to connector A for step 1922 for FIG. 19.

In the case that the evaluation is acceptable in decision 1972, the process continues to step 1982. Step 1982 is an optional step based on the evaluation of the generated response being acceptable. In step 1982, the generated response is automatically exported to a workflow creation tool to populate the graphical widgets on the GUI with at least a portion of the generated response from the generative deep learning system. The process continues to decision 1992. If more input from the author is requested, the process returns to connector C for step 1912 for FIG. 19. In the event that no further input is requested, the process ends in step 1994.

### Computer Hardware

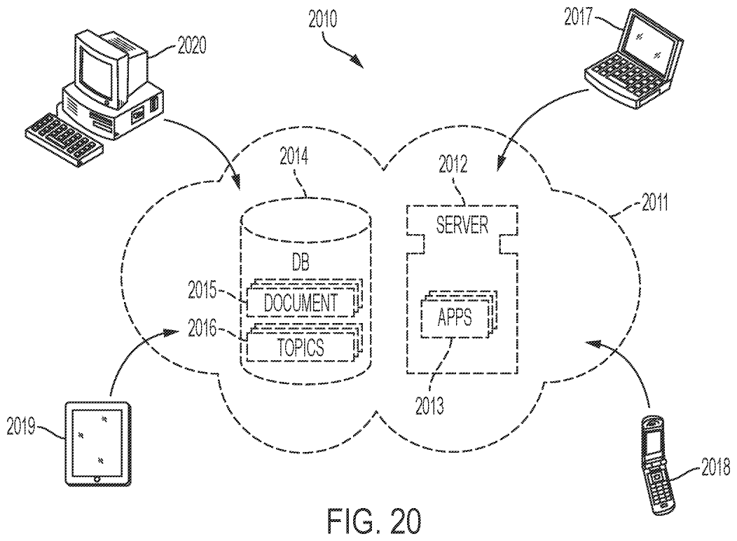

FIG. 20 is an example of a high-level computer architecture 2000 that can implement methods of FIGS. 1-19 described herein, in accordance with one embodiment. The above-described methods can be implemented on a computer using well-known computer processors, memory units, storage devices, computer software, and other components.

The system can operate via a cloud computing environment, which allows end authors to access and utilize remotely-stored applications 2049 without requiring the authors to install software or personal data. Instead, clients receive cloud-based software 2013 and stored data. Each of the end authors operates computing devices 2017-2020, including a desktop computer 2020, laptop 2017, tablet 2019, or cellular telephone 2018, as well as other types of computing devices, to access the applications 2013 and data 2015, 2016 stored on remote servers 2012 and databases 2014, respectively, via a network 2011. At a minimum, each computing device should include access to the Internet or private network and have the ability to execute an application.

The author's device 2012-2014 and servers 2015, 2021 include components conventionally found in general-purpose programmable computing devices, such as a central processing unit, memory, input/output ports, network interfaces, and non-volatile storage, although other components are possible. Moreover, other information sources in lieu of or in addition to the servers, and other information consumers, in lieu of or in addition to author devices are possible.

Once accessed, the application 2013 allows the author to visually construct a search query, visualize the results, filter the results, and track the author's progress through the results. In one example, the search query is applied to a set of documents 2015. The documents most relevant to the query are selected and clustered to determine relevant topics for the query. Specifically, the topics can be determined using a topic-modeling algorithm. Subsequently, the topics are returned to the author as results of the query search. In a further embodiment, the query is directly applied to predetermined topics 2016 that are also stored in the database 2014. The document database 2014 can also include indices (not shown) of topics and documents to identify the documents associated with each topic and the topics associated with each document. Relevance of the search query to the documents and topics can be based on, for example, a cosine similarity, as well as other similarity measures.

The author devices 2017-2020 and servers 2012 can include one or more modules for carrying out the embodiments disclosed herein. The modules can be implemented as a computer program or procedure written as source code in a conventional programming language and is presented for execution by the central processing unit as object or byte code. Alternatively, the modules could also be implemented in hardware, either as integrated circuitry or burned into read-only memory components. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a computer-readable medium and transferred to the processor for execution as is known in the art. The structures and procedures shown above are only a representative example of embodiments that can be used to facilitate the embodiments described above.

### Non-Limiting Examples

Although specific embodiments of the invention have been discussed, those having ordinary skill in the art will understand that changes can be made to the specific embodiments without departing from the scope of the invention. The scope of the invention is not to be restricted, therefore, to the specific embodiments, and it is intended that the appended claims cover any and all such applications, modifications, and embodiments within the scope of the present invention.

It should be noted that some features of the present invention may be used in one embodiment thereof without the use of other features of the present invention. As such, the foregoing description should be considered as merely illustrative of the principles, teachings, examples, and exemplary embodiments of the present invention, and not a limitation thereof.

Also, these embodiments are only examples of the many advantageous uses of the innovative teachings herein. In general, statements made in the specification of the present application do not necessarily limit any of the various claimed inventions. Moreover, some statements may apply to some inventive features but not to others.

The description of the present invention has been presented for purposes of illustration and description and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

### Incorporated References

The following patent, patent publications, and other references listed in the Information Disclosure are hereby incorporated by reference in their entirety:
U.S. Pat. No. 11,393,202, entitled “Augmented Reality Support Platform”, with attorney docket number 20210002US01.
U.S. patent application Ser. No. 17/806,177, entitled “Augmented Reality Support Platform”, with attorney docket number 20210002US02
U.S. patent application Ser. No. 18/051,575, entitled “Stable Object Detection And Creation Of Anchors In Augmented Reality Scenes”, with attorney docket number 20220191
U.S. patent application Ser. No. 18/057,341, entitled “Labeled Image Capture Based On Frozen Mesh”, with attorney docket number 20220134.
U.S. patent application Ser. No. 17/933,930, entitled “System And Method To Create Object Detection Scanning Plans”, with attorney docket number 20220124.
U.S. patent application Ser. No. 17/804,743, entitled “Object Detection Based Zonal OCR In An AR Context”, with attorney docket number 20220041.
U.S. patent application Ser. No. 17/804,730, entitled “LED Detection In An AR Context”, with attorney docket number 20220040.
U.S. patent application Ser. No. 17/804,750, entitled “Context Sensitive Functions In AR Experiences”, with attorney docket number 20220039.
U.S. patent application Ser. No. 17/804,712, entitled “System and Method to Validate Task Completion”, with attorney docket number 20220038.
U.S. Pat. No. 9,875,299, entitled “System And Method For Identifying Relevant Search Results Via An Index”, with attorney docket number 87922713.
U.S. Pat. No. 9,286,377, entitled “System And Method For Identifying Semantically Relevant Documents”, with attorney docket number 86820732.
U.S. Pat. No. 11,182,411, entitled “Combined Data Driven And Knowledge Driven Analytics”, with attorney docket number 87992551.
U.S. Pat. No. 11,200,457, entitled “System And Method Using Augmented Reality For Efficient Collection Of Training Data For Machine Learning”, with attorney docket number 88210972.
U.S. Pat. No. 10,699,165, entitled “System And Method Using Augmented Reality For Efficient Collection Of Training Data For Machine Learning”, with attorney docket number 87994384.
U.S. Pat. No. 11,610,415, entitled “Apparatus And Method For Identifying An Articulatable Part Of A Physical Object Using Multiple 3D Point Clouds”, with attorney docket number 88266622.
U.S. Pat. No. 11,610,415, entitled “Apparatus And Method For Identifying An Articulatable Part Of The Physical Object Using Multiple 3D Point Clouds”, with attorney docket number 88022424.
US Patent Publication No. 2020/0210967, entitled “Method And System For Rule-Based Augmentation Of Perceptions”, with attorney docket number 88024854
U.S. Pat. No. 11,270,123, entitled “System And Method For Generating Localized Contextual Video Annotation”, with attorney docket number 88193410.
US Patent Publication No. 2020/0318229, entitled “Using Multiple Trained Models To Reduce Data Labeling Efforts”, with attorney docket number 88202689
U.S. Pat. No. 9,042,659, entitled “Method And System For Fast And Robust Identification Of Specific Products In Images”.
US Patent Publication No. 2019/0340507, entitled “Method For Reducing Computational Complexity”.
U.S. Pat. No. 10,268,912, entitled “Offline, Hybrid And Hybrid With Offline Image Recognition”.

What is claimed is:

1. A computer-implemented method to create a structured series of graphical widgets on a graphical user interface (GUI) of a computer system, the graphical widgets forming part of a multimedia guidance procedure, the method comprising:
receiving an author's input, via a GUI, for populating multimedia content into a UI card design pattern that groups related information in a flexible-size container visually resembling a playing card for at least a portion of a multimedia guidance procedure as part of a workflow creation tool;
converting at least a portion of the author's input into one or more search parameters for a search query that is compatible with at least one of a search engine, a public database query, a private database query, or a combination thereof; and
associating the one or more search parameters with a search field that has been inserted into the flexible-size container.

2. The computer-implemented method of claim 1, wherein the receiving, via the GUI, the author's input further includes receiving a position of a search field to insert into the flexible-size container.

3. The computer-implemented method of claim 1, further comprising:
receiving from a user, via the GUI, a selection of the search field with one or more parameters to modify the one or more search parameters.

4. The computer-implemented method of claim 1, wherein the receiving the author's input, via the GUI, further includes receiving one or more of text, audio, image, a 3-D object, and video.

5. The computer-implemented method of claim 1, wherein the series of graphical widgets further includes a button, and in response to the button being selected a user performs at least one of:
navigation to another UI card design pattern,
image recognition,
state recognition,
audio recognition, or
a combination thereof.

6. The computer-implemented method of claim 1, further comprises:
presenting to the author, via the GUI, two or more UI card design patterns via the GUI; and
receiving the author's input, via the GUI, to designate a relationship between the two or more UI design patterns on the GUI as one of hierarchical relationship or another relationship therebetween.

7. The computer-implemented method of claim 1, further comprises:
presenting to the author a 3-D object; and
receiving from the author, via the GUI, an initial orientation of the 3-D object to be rendered in the UI card design pattern.

8. The computer-implemented method of claim 7, further comprises:
receiving from the user, via the GUI, an input to manipulate the 3-D object through panning, rotating, and zooming.

9. The computer-implemented method of claim 7, further comprises:
presenting to the author the 3-D object; and
receiving from the author, via the GUI, one or more 3-D animation overlays using images applied to the 3-D object to be rendered in the UI card design pattern.

10. The computer-implemented method of claim 7, further comprises:
presenting to the author the 3-D object in an orientation that has been selected; and
receiving from the author, via the GUI, a position to overlay a guidance icon to indicate further information is available for that portion of the 3-D object.

11. The computer-implemented method of claim 1, further comprises:
receiving from the author, via the GUI, a selection of an object and state detection machine learning model from a plurality of object and state detection machine learning models;
receiving from the author, via the GUI, a label in a machine learning model, the label corresponding to at least a portion of an object; and
in response to receiving at least one image from the user using a camera, performing on the image at least one of object and state detection the selected object and state detection machine learning model, image recognition, or a combination to detect the at least the portion of the object.

12. The computer-implemented method of claim 11, further comprising:
receiving the author's input, via the GUI, to designate an action in the multimedia guidance procedure to take in response to detecting the portion of the object being successful.

13. The computer-implemented method of claim 11, further comprising:
receiving the author's input, via the GUI, to designate an action in the multimedia guidance procedure to take in response to detecting the portion of the object being unsuccessful.

14. The computer-implemented method of claim 1, further comprises:
receiving from the author, via the GUI, a position to overlay a guidance icon to invoke an audio detection algorithm using audio matching to identify a sound to validate at least a portion of an audio sound for a step in the multimedia guidance procedure.

15. The computer-implemented method of claim 14, further comprising:
receiving the author's input, via the GUI, to designate an action in the multimedia guidance procedure to take in response to detecting the sound of the object being successful.

16. The computer-implemented method of claim 14, further comprising:
receiving the author's input, via the GUI, to designate an action in the multimedia guidance procedure to take in response to detecting the portion of the object being unsuccessful.

17. The computer-implemented method of claim 1, wherein the receiving, via the GUI, the author's input further includes receiving a machine-readable identifier to associate with the flexible-size container.

18. A computer system to create a structured series of graphical widgets on a graphical user interface (GUI) of the computer system, the graphical widgets forming part of a multimedia guidance procedure, the system comprising:
a processor device; and
a memory operably coupled to the processor device and storing computer-executable instructions causing:
receiving an author's input, via a GUI, for populating multimedia content into a UI card design pattern that groups related information in a flexible-size container visually resembling a playing card for at least a portion of a multimedia guidance procedure as part of a workflow creation tool;
converting at least a portion of the author's input into one or more search parameters for a search query that is compatible with at least one of a search engine, a public database query, a private database query, or a combination thereof; and
associating the one or more search parameters with a search field that has been inserted into the flexible-size container.

19. The computer system of claim 18, wherein the receiving, via the GUI, the author's input further includes receiving a position of a search field to insert into the flexible-size container.

20. The computer system of claim 18, further comprising:
receiving from a user, via the GUI, a selection of the search field with one or more parameters to modify the one or more search parameters.
